(19) United States
(12) Patent Application Publication
(10) Pub. No.: US 2017/0019588 A1
(43) Pub. Date: Jan. 19, 2017

(54) CAMERA SYSTEM

(71) Applicant: Catherine Ann Gordon, Beavercreek, OH (US)

(72) Inventor: Catherine Ann Gordon, Beavercreek, OH (US)

(21) Appl. No.: 14/800,838

(22) Filed: Jul. 16, 2015

(51) Int. Cl. H04N 5/232

(52) U.S. Cl. CPC H04N 5/23222; H04N 5/23203

(57) ABSTRACT

A camera system is disclosed herein that includes a camera apparatus and a control apparatus. The camera apparatus has a base, a camera movably coupled to the base and providing an output, a positioner operatively coupled to the camera to adjust a tilt position and/or a pan position of the camera, and a camera apparatus wireless communication device operatively coupled to the camera and/or the positioner to control the camera and/or the positioner and transmit a the camera output. The camera apparatus is easily moveable between filming locations. The controller includes a manually controllable controller, a control apparatus wireless communication device to wirelessly receive the camera output from and send control signals to the camera apparatus wireless communication device, and a display for displaying the camera output. The control apparatus is physically decoupled from the camera apparatus to allow a user to control the camera from a remote location.

### TECHNICAL FIELD

The present disclosure relates to camera systems and, more particularly, to remotely controlled camera systems.

### BACKGROUND

Camera systems are used to record video or still images of various live events, such as athletic events, concerts, demonstrations, ceremonies, and the like. In particular, capturing video images of sporting events is growing increasingly more popular as a tool for coaches and others to identify opportunities for improvement, among other uses. For many existing camera systems used by videographers to capture video images of sporting events, the camera controls are physically coupled to the camera such that the videographer must remain at the camera's physical location during the event to operate the camera or the camera system is linked via cabling and is set permanently in one place. In addition, many existing camera systems are often cumbersome to setup and move, often requiring the entire apparatus to be disassembled prior to moving to a different event.

### SUMMARY

According to one aspect, camera systems are disclosed that include a camera apparatus and a control apparatus. The camera apparatus includes a base; a camera configured to provide an output and movably coupled to the base such that a distance between the camera and the base is adjustable; a positioner operatively coupled to the camera, the positioner configured to adjust at least one of a tilt position or a pan position of the camera; a first wireless receiver operatively coupled to at least one of the camera or the positioner; and a wireless transmitter operatively coupled to the camera to receive and transmit the output from the camera. The first wireless receiver is configured to receive wireless control signals to control at least one of the camera or the positioner. The control apparatus includes a manually controllable controller configured to directly transmit wireless control signals to the first wireless receiver to control at least one of the camera or the positioner. The control apparatus also includes a second wireless receiver configured to directly receive the output from the wireless transmitter and a display operatively coupled to the second wireless receiver and configured to display the output.

### BRIEF DESCRIPTION OF THE DRAWINGS

Many aspects of the disclosure can be better understood with reference to the following drawings. The components in the drawings are not necessarily to scale, emphasis instead being placed upon illustrating certain principles of the present disclosure. Moreover, in the drawings, like reference numerals designate corresponding parts throughout the several views.

FIG. 1 is a side perspective view of an embodiment of a camera system.

FIG. 2 is a side perspective view of another embodiment of the camera system.

FIG. 3 is a side perspective view of a camera apparatus.

FIG. 4 is a front perspective view of a control apparatus.

FIG. 5 is a side perspective view of another embodiment of the camera apparatus.

FIG. 6 is a wiring diagram for one embodiment of the camera system.

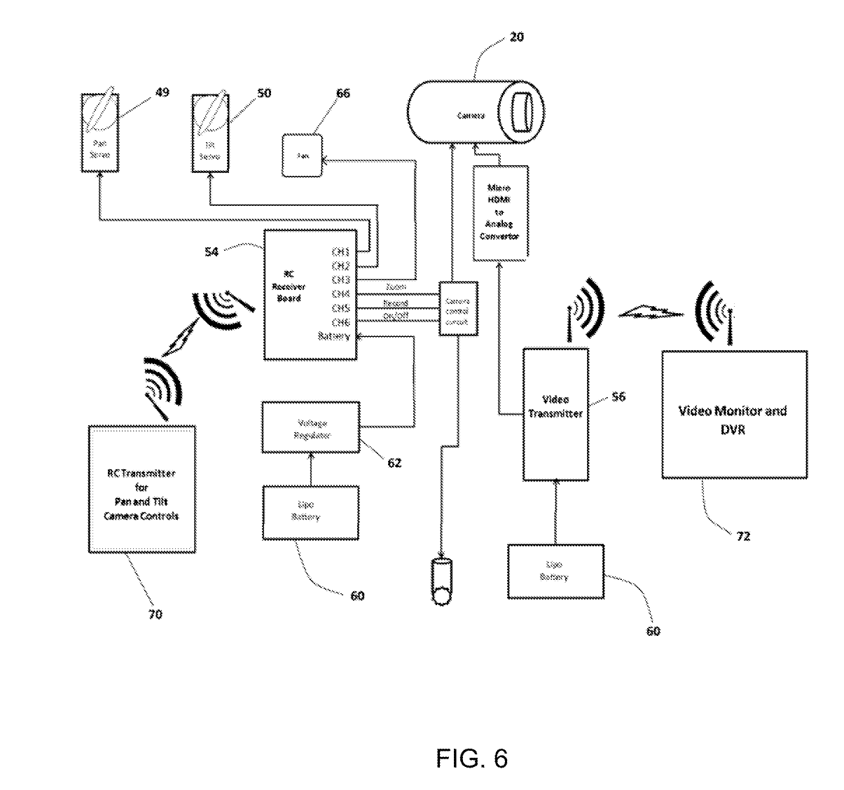

### DESCRIPTION

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

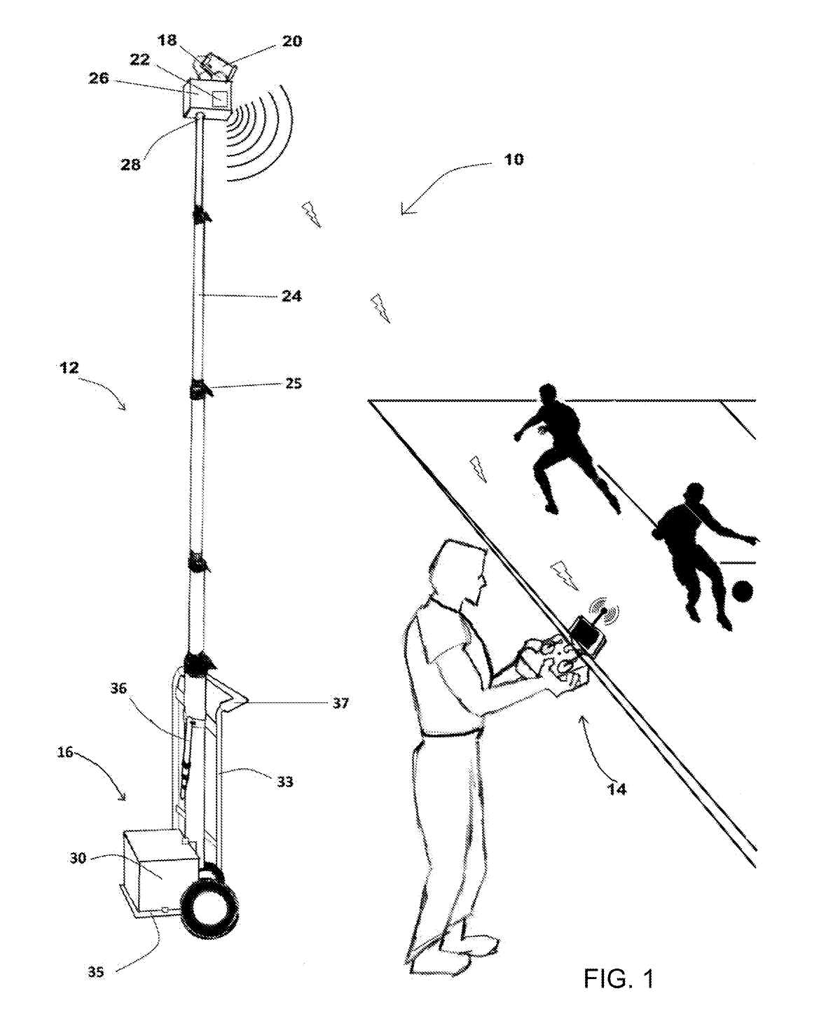

Referring now to FIG. 1, one embodiment of the camera system 10 is disclosed herein for capturing video or still images. The camera system 10 includes, generally speaking, a camera apparatus 12 and a control apparatus 14 capable of wirelessly transmitting control signals to and receiving output data from the camera apparatus 12. The camera apparatus 12 can include a base 16, a positioner 18, a camera 20, and a camera apparatus wireless communication device 22. The camera 20 may be coupled to the positioner 18, which may in turn be coupled to the base 16. The camera apparatus 12 may also include a support member 24 or height adjusting mechanism coupled to the base 16, and a housing 26 coupled to the support member 24. The positioner 18 and/or the camera 20 may be coupled to the housing 26 or to the support member 24. The camera apparatus wireless communication device 22 may be operatively and removably attachable to the positioner 18 and/or the camera 20 for sending and receiving data therefrom.

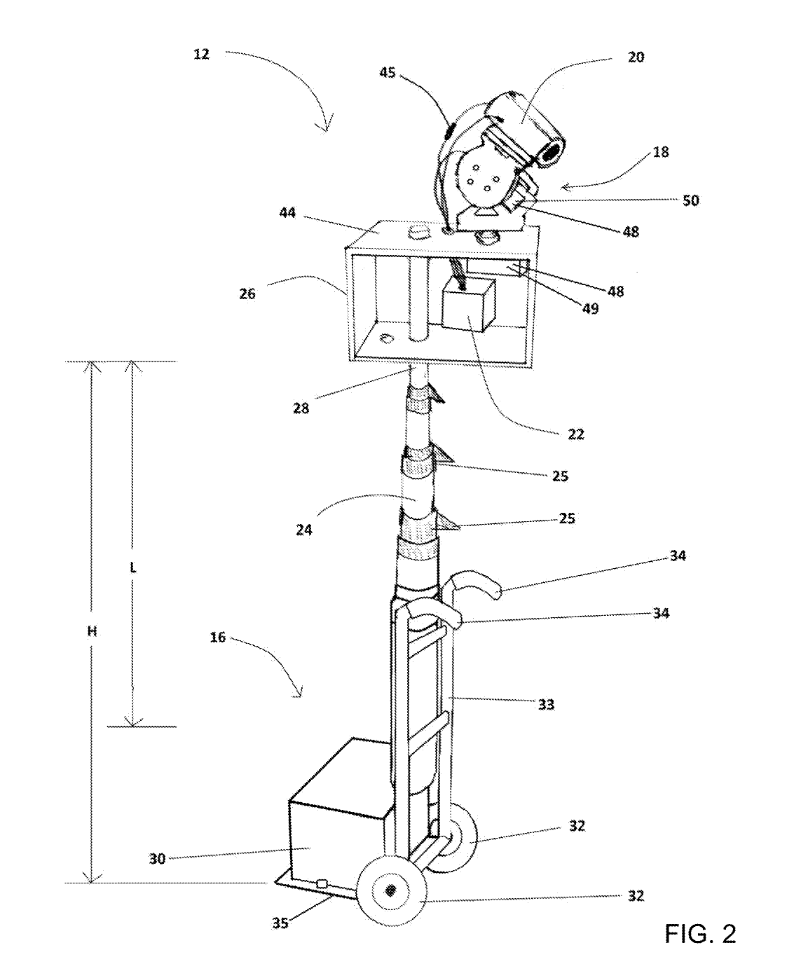

Referring now to FIGS. 1-2, the base 16 of the camera apparatus 12 can be weighted (i.e. having a weight of at least about 1 lb., or at least 17 lb., and/or at least about 20 lb., and/or at least about 30 lbs. in one case) to provide ballast and stability to the camera apparatus 12 during use. The base 16 may include or be coupled to a power supply 30 that can provide substantial weight to ballast the camera apparatus 12. The power supply 30 may be configured to recharge batteries used to operate the camera 20. The power supply 30 may also be configured to provide power to the camera 20, positioner 18, and other components. The power supply 30 may be a large capacity rechargeable battery (power pack), an electric generator, or other power supply system.

The base 16 may also have one or more wheels 32 to facilitate manually rolling or moving the camera apparatus 12 between filming locations. The base 16 may have one or more handles 34 extending outward to further facilitate moving the camera apparatus 12. The handles 34 may be used in conjunction with the wheels 32 to manually reposition the camera apparatus 12. The base 16 may also have a stabilizing mechanism 36 (shown in FIG. 1) such as a tripod attachment or supporting legs, for example, for stabilizing the camera apparatus 12 when the camera apparatus 12 is setup on uneven ground or in windy conditions. The stabilizing mechanism 36 may have one or more stabilizing members (not shown) extending outward and downward therefrom to engage a ground surface to provide a wider support base and prevent the camera apparatus 12 from tipping over.

In one embodiment of the camera apparatus 12 shown in FIG. 2, the base 16 includes or takes the form of a hand truck 33, a power supply 30 (power pack) removable from the hand truck 33, and an engaging apparatus 37 (FIG. 1) for removably attaching the support member 24 to the base 16. The power supply 30 rests on the nose plate 35 of the hand truck 33.

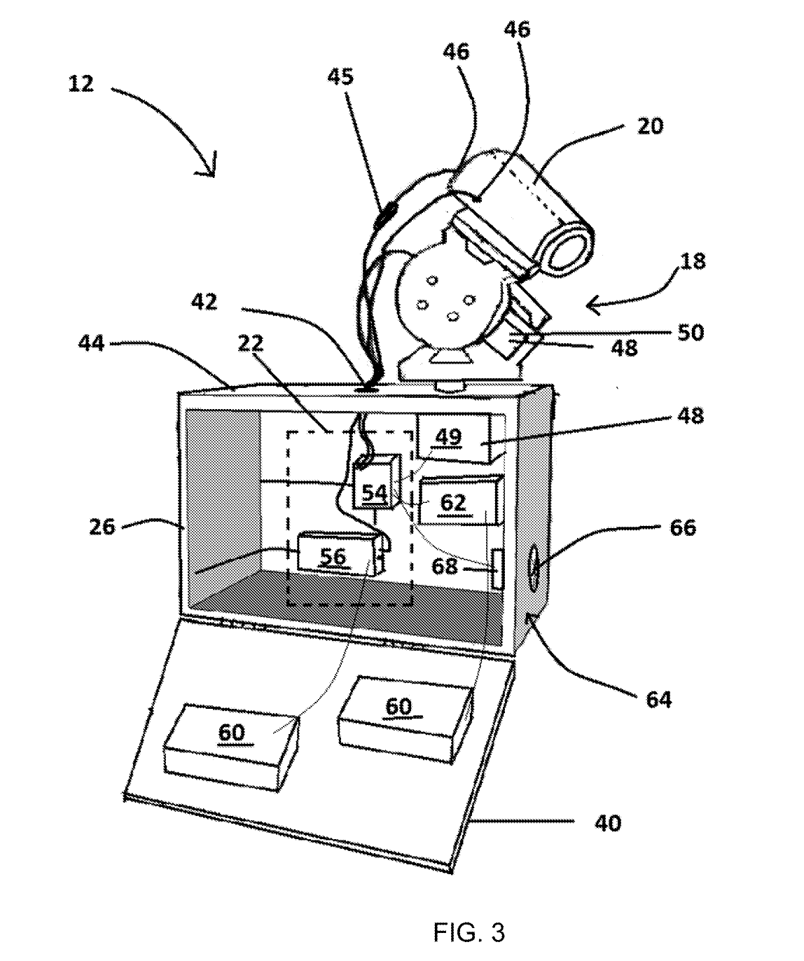

The support member 24 may be coupled to or integrated with the base 16 and extends from the base 16 to the housing 26, positioner 18, and camera 20. The support member 24 may be capable of extending and retracting along its length to change the length L of the support member 24, thereby adjusting the relative distance between the camera 20 and the base 16. In one embodiment, the support member 24 may be a telescoping pole as shown in FIGS. 2-3. The support member 24 may have one or more locking mechanisms 25, such as quick release clamps, which may be used to lock the support member 24 at a selected height. In another embodiment, the support member 24 may include a motorized device (not shown) for raising and lowering (extending and retracting) the support member 24. In some embodiments, the motorized device may be configured to receive a control signal from the control apparatus 14 to control extension and/or retraction of the support member 24. In another embodiment, the support member 24 has a fixed length, and the camera 20 and/or positioner 18 are releasably attachable to the support member 24 at various locations therealong, or slideable therealong.

The camera apparatus 12 can position the camera 20 at a height H above the ground. The camera apparatus 12 may in one case provide a minimum height of about 4 feet, and a maximum height of about 20 feet or more. In one embodiment, the camera apparatus 12 is capable of providing camera heights H in a range of about 4 feet to about 15 feet in one case, or H in a range of about 5 feet to about 20 feet in another case. It should be appreciated that the support member 24 is capable of providing intermediate heights between the minimum and maximum heights.

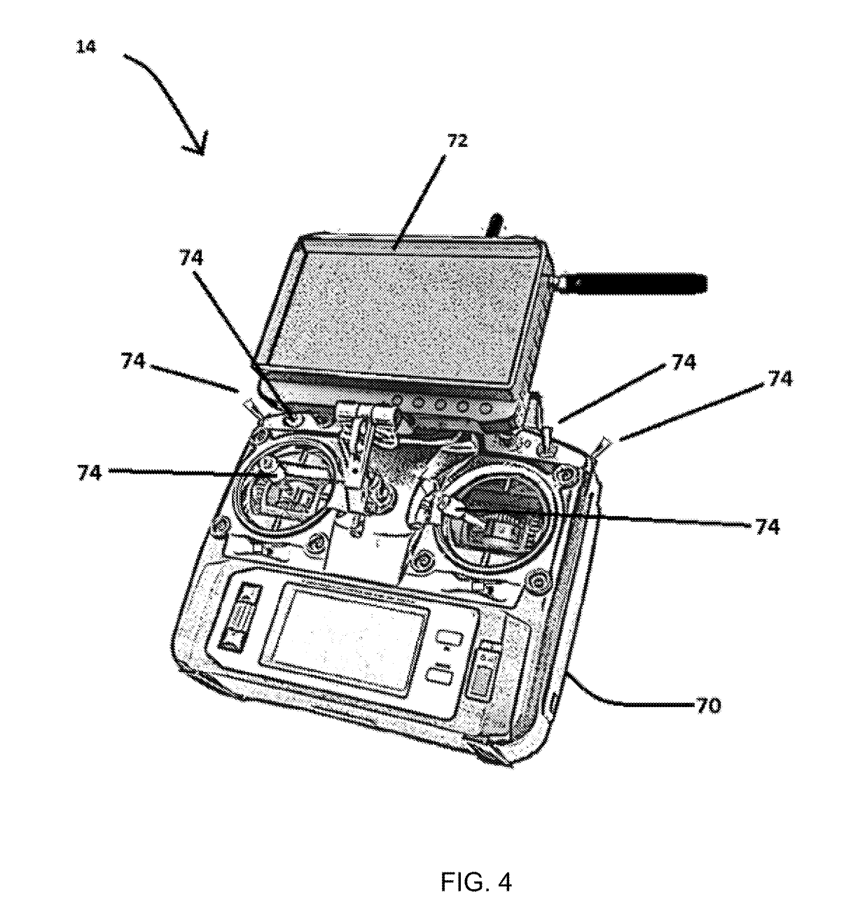

As shown in FIGS. 1-3, the housing 26 can be coupled to the upper portion 28 of the support member 24. The housing 26 provides a closed/sealed or generally closed/sealed structure to which various components of the camera apparatus 12 may be attachable and/or may be enclosed to shield the components therein from ambient conditions. Although the housing 26 is shown in FIGS. 1-3 as being enclosed on all sides, it should be appreciated that the housing 26 could, in some cases, be at least partially open to the atmosphere on one or more sides. The housing 26 may include a door 40 (FIG. 4) to provide access to components contained within the housing 26 and one or more openings 42 to accommodate wiring and other components. The openings 42 and the door 40 may include one or more sealing members (not shown) to prevent or reduce moisture penetration into the housing 26.

Referring now to FIG. 3, the housing 26 may include a mounting plate 44 forming one or more sides of the housing 26. The mounting plate 44 is shown in FIGS. 1-2 as forming the top of the housing 26, but it should be appreciated that the mounting plate 44 could be positioned on or form any of the other sides of the housing 26. The openings 42 may be positioned in the mounting plate 44 for mounting the positioner 18 and/or the camera 20 thereto. The mounting plate 44 provides mounting support for the positioner 18 and/or the camera 20. In the embodiment shown in FIGS. 2-4, the positioner 18 is coupled to the mounting plate 44 and the camera 20 is removably attachable to the positioner 18.

The camera 20 may have one or more of a zoom lens, an on/off function, a record function, and one or more memory modules for storing recorded images. The camera 20 may be capable of capturing video images and may have a still photo function. The camera 20 may be releasable or removable from the positioner 18/camera apparatus 12 such that the camera 20 can be removed and used as a stand-alone camera device, independent of the camera system 10. The camera 20 may be any of a number of commercially available video cameras or camcorders, such as those produced and marketed by Sony or Canon, for example.

The camera 20 can have one or more ports 46 for removably receiving one or more wires/cables for sending and/or receiving electrical communication signals. In one embodiment, the camera 20 has a single port 46 configured to provide for both input signals to and output signals from the camera 20. In other embodiments, the camera 20 can have a separate input port and output port. In another embodiment, ports 46 include or take the form of a LANC port for receiving input/control signals and a video output port. The camera 20 is configured to generate an output, which includes images captured by the camera 20 and/or related data, including sound information corresponding to the video images, date/time stamp information, metadata, etc. The camera 20 may also store the video output in the one or more memory modules of the camera 20, or has media writing capabilities for storing data on data cards, DVDs, or other media.

The positioner 18 is capable of rotating the camera 20 about one or more perpendicular axis to change an orientation of the camera 20 relative to the base 16/ground. The positioner 18 may be capable of panning (i.e., horizontal movement pivoting about a generally vertical axis relative to the ground, for example) and/or tilting (i.e., vertical movement pivoting about a generally horizontal axis relative to the ground, for example) the camera 20 to change a field of view of the camera 20 and the images captured by the camera 20. The positioner 18 may include one or more servo motors 48 to move the positioner 18 and/or the camera 20 relative to the base 16. In one embodiment shown in FIG. 3, the positioner 18 includes a pan servo motor 49, which is positioned inside of the housing 26, and a tilt servo motor 50, which is positioned above the mounting plate 44 of the housing 26 outside of the housing 26. In another embodiment (not shown), the pan and tilt servo motors 49, 50 are both positioned outside of the housing 26, or both inside the housing 26. The pan servo 49 may have a range of motion of at least 270° in one case, or at least 180° in another case, or at least 135° in yet another case. The tilt servo 50 has a range of motion of at least about 180° of rotation in one case, or at least about 135° of rotation in another case. In some embodiments, the pan and tilt servos 49, 50 may have a range of less than 135°.

The pan and tilt servo motors 49, 50 have a high speed and fast response to a control signal. The speed of the pan and tilt servo motors 49, 50 can, in one case, be defined as the time in seconds required to move the servo through sixty degrees of rotation about the motor's axis of rotation when the servo is unweighted (i.e. the servo is not under a load). In one embodiment, each servo motor 49, 50 has a speed of less than about 0.6 seconds, or less than about 0.30 seconds in another embodiment, or less than about 0.17 seconds in yet another embodiment, or less than about 0.12 seconds in yet another embodiment.

The positioner 18 may have one or more electrical contacts or electrical connections (not shown) for receiving control wiring to operatively couple the positioner 18 to the camera apparatus wireless communication device 22 for receiving control signals. Electrical connections may be positioned on each of the pan servo motor 49 and the tilt servo motor 50.

Referring to FIG. 2, the camera apparatus 12 includes a camera apparatus wireless communication device 22, which may be referred to herein in the alternative as the first wireless communication device 22. The camera apparatus wireless communication device 22 may be a transceiver configured to both receive and transmit data. The camera apparatus wireless communication device 22 is operatively coupled to at least one of the positioner 18 or camera 20 and is configured to wirelessly receive control signals to control at least one of the positioner 18 or the camera 20, or both. The control provided by the camera apparatus wireless communication device 22 may include adjusting the servo motors 49, 50 to pan or tilt the camera 20 and/or operating the zoom, record, or still photo operations of the camera 20, among other functions. The camera apparatus wireless communication device 22 is also configured to receive and wirelessly transmit the output from the camera 20. The camera apparatus wireless communication device 22 is configured to communicate with the control apparatus 14, and may be configured to receive control signals and transmit output data using a wireless network or may be configured to communicate directly with the control apparatus 14.

In the embodiment in FIG. 3, the camera apparatus wireless communication device 22 is shown as including a camera apparatus wireless receiver 54 (referred to herein as a first wireless receiver) and a camera apparatus wireless transmitter 56 (referred to herein as a first wireless receiver), separate from the camera apparatus wireless receiver 54. The camera apparatus wireless receiver 54 may include an antennae for receiving wireless control signals and a processor for converting the wireless control signals to electrical signals and directing or allocating the control signals to one or more components of the camera apparatus 12 (e.g., positioner 18 or camera 20). The camera apparatus wireless receiver 54 may be operatively coupled to one or more of the positioner 18, camera 20, a cooling switch 68, or other component to communicate one or more control signals thereto. The camera apparatus 12 may have or utilize a camera interface 45 for operatively and detachably coupling the camera 20 to the camera apparatus wireless receiver 54 via camera port(s) 46.

The camera apparatus wireless transmitter 56 may be operatively attachable to the camera 20 to electronically receive the output from the camera 20. The camera apparatus wireless transmitter 56 is configured to convert the electrical output into a wireless output and transmit or broadcast the wireless output via an antenna in one case. In one embodiment, the camera apparatus wireless transmitter 56 converts the output from the camera 20 into a radio frequency output. The camera apparatus wireless transmitter 56 may also be electrically coupled to one or more of the positioner 18, cooling fan 66, power regulator 62, batteries 60, or other sensors, switches, or components that may be incorporated into the camera system 10 for communication of one or more supplemental outputs from the camera apparatus 12 to the control apparatus 14 or a network.

Referring to FIG. 3, the camera apparatus 12 can include one or more rechargeable batteries 60 and a voltage regulator 62 operatively coupled to the rechargeable batteries 60 to condition the power output from the batteries 60 for use with one or more of the positioner 18, the camera 20, the camera apparatus wireless receiver 54, the camera apparatus wireless transmitter 56, or other components. The batteries 60 and regulator 62 are not shown in the embodiment in FIG. 2. Spare rechargeable batteries (not shown) may be available for switching out when the batteries 60 run low. As previously discussed, the spare batteries may be recharged from the power pack 30 integrated with or positioned on the base 16 while the camera system 10 is in operation. In one embodiment, the power pack 30 on the base 16 is operatively coupled to one or more of the positioner 18, camera 20, camera apparatus wireless communication device 22 (including camera apparatus wireless receiver 54 and/or camera apparatus wireless transmitter 56), or other component, via a wire extending to housing 26, to provide power thereto. In another embodiment, the power pack 30 is not operatively coupled to the positioner 18, camera 20, wireless communication device 22, or other component via a wire, but is used to recharge batteries 60 for use with the camera apparatus 12.

The camera apparatus 12 may optionally include a cooling system 64 that includes a cooling fan 66 and a cooling switch 68 operatively coupled thereto. The cooling fan 66 may be positioned in a side of the housing 26 and, during operation, may direct air across components positioned in the housing 26 to remove heat therefrom. The cooling system 64 may be operatively coupled to the power supply system 58, and the cooling switch 68 may be electrically connected to the camera apparatus wireless receiver 54 such that the cooling switch 68 may receive a control signal from the control apparatus 14 via the camera apparatus wireless communication device 22. Through its electrical connection with the camera apparatus wireless communication device 22, the cooling system 68 may thereby be turned on and off remotely by the control apparatus 14. The cooling system 64 may be disconnected in cool weather or in other conditions which present minimal risk of overheating components of the camera apparatus 12.

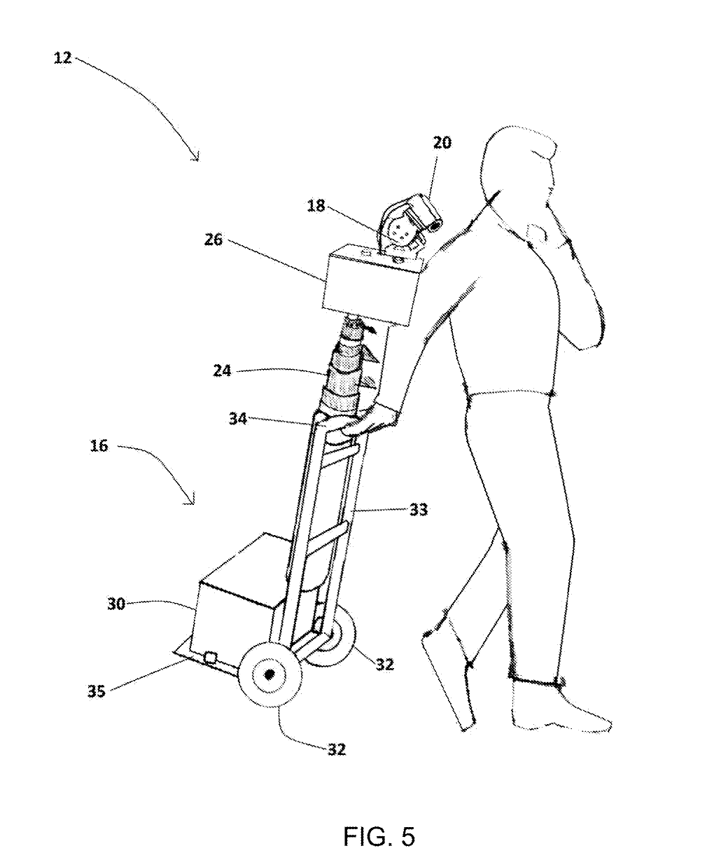

Referring to FIG. 5, the camera apparatus 12 may be manually moveable between various locations. In one embodiment, the camera apparatus 12—including the base 16, power pack 30, hand truck 33, positioner 18, camera 20, housing 26, and support member 24—has a total weight of less than 200 pounds, or less than about 100 pounds in another embodiment, or less than about 70 pounds in yet another embodiment. The camera apparatus 12 can be easily manually moveable by a single person, in one case, by tilting the camera apparatus 12 at an angle onto the wheels 32 maneuvering the camera apparatus 12 into position using the handles 34.

The camera apparatus 12 may able to be disassembled into one or more parts for ease of storage or for shipping to a filming location. The camera 20 may be detached from the positioner 18 or housing 26, and the housing 26 may be detached from the support member 24. In some embodiments, the positioner 18 may also be detached from the housing 26 for storage or shipping. Batteries 60 (FIG. 3) may be removed from the housing 26. The support member 24 may be further detached from the base 16. In one embodiment, the support member 24 may be retracted to its shortest length L before or after removing the support member 24 from the base 16. In one embodiment, the base 16 may be further disssembled into one or more of the hand truck 33, the power supply 30 and the stabilizing mechanism.

Referring now to FIG. 4, the control apparatus 14 includes a controller 70, a controller wireless transmitter (not shown) operatively coupled to the controller 70, a display 72, and a controller wireless receiver (not shown) operatively coupled to the display 72. The controller 70 may be a radio frequency controller having one or more input devices 74 for manual manipulation by a user to create one or more control signals for wireless transmission to the camera apparatus 12. The input devices 74 may include one or more of control levers, toggle switches, joysticks, control knobs, trackballs, touch screens, buttons, a mouse, a kinetic device, or other user input device. In one embodiment, the controller 70 is a manually controllable controller that generates control signals from manually manipulated user input devices 74 and transmits the control signals to the camera apparatus 12. In one embodiment, the controller wireless transmitter may be incorporated into the controller 70. In another embodiment, the controller wireless transmitter may be separate from but operatively coupled to the controller 70 for transmitting control signals to the camera apparatus 12.

The input devices 74 may enable the user to create or manipulate a control signal relating to operation of the camera system 12, such as pan and/or tilt of the positioner 18, zoom, on/off, record and/or still photo capture operations of the camera 20, and/or operation of the cooling system 64. In one embodiment, the input devices 74 include a first control joystick/lever for manipulating a pan function of the positioner 18, a second control joystick/lever for manipulating a tilt function of the positioner, and a plurality of toggle switches for controlling one or more of a zoom function, a power on/off function, and a record function of the camera 20 and an on/off function of the cooling system 64. The control apparatus 14 may also have one or more indicators (not shown). The control apparatus 14 may be configured to wirelessly receive one or more status output signals from the camera apparatus 12 and change a condition of the indicators in response to the received status output signals. The indicators may provide information to the user regarding the status of at least one of the positioner 18, camera 20, power supply system 58, cooling system 64, or other component of the camera system 10.

The controller wireless transmitter, also referred to herein as the second wireless transmitter, transmits the one or more control signals, generated by the user input, to the camera apparatus 12. The control apparatus 14 may also include a power supply, which may be in the form of a battery, in one case, and may include a neck strap for supporting the control apparatus 14 in a comfortable position for the user. The control apparatus 14 can be physically decoupled/untethered from the camera apparatus 12 such that the user is free to move the control apparatus 14 to a location remote from the camera apparatus 12 (see FIG. 1). In other words, in one case, no physical structure or wire connects or tethers the control apparatus 14 to the camera apparatus 12. The control apparatus 14 may be temporarily tethered to the camera apparatus 12 in some cases, such as for the purposes of recharging one or more rechargeable batteries (not shown) for the control apparatus 14 while continuing to operate the camera system 10.

The display screen 72 of the control apparatus 14 may be operatively coupled to the controller wireless receiver (also referred to herein as the second wireless receiver) to receive the camera output. The display 72 reassembles the camera output signal received from the controller wireless receiver into a visually discernable image, which is then displayed on the display 72. The display 72 may be integral with or removably attachable to the controller 70. The display 72 can have a sun shade to make viewing the display easier for the user. The control apparatus 14 may have a memory (not shown) and may be configured to store the output received from the controller wireless receiver in the memory in the manner of a DVR function. The control apparatus 14 may include a display controller (not shown) having a processor and a memory, in which instructions are stored that, when run by the display controller, cause the display 72 to display one or more icons on the screen. The icons may be indicators or may comprise one or more menu selections for customize use and operation of the display 72. In one embodiment, the display 72 may be a touch screen and the processor may be configured to receive one or more user inputs from the touch screen.

In one embodiment, the control apparatus 14 may have a single control apparatus wireless communication device, which may be a transceiver or include two separate wireless devices (transmitter and receiver), operatively coupled to the controller 70 and the display 72 for transmitting control signals to and receiving output from the camera apparatus 12. The control apparatus wireless communication device may also be referred to herein as the second wireless communication device.

Wireless communication/transfer of data between the control apparatus 14 and the camera apparatus 12 may be by radio frequency transmission. The camera apparatus wireless communication device 22 (which may be a transceiver or include first wireless receiver 54 and first wireless transmitter 56) and the control apparatus wireless communication device (which may be a transceiver or include second wireless receiver and second wireless transmitter) may send and receive data using radio waves of various frequencies available for personal or business use. The radio frequency may be any allowable radio frequency. For example, the radio frequencies may be in allowable regions of the UHF or SHF radio frequency bands (300 MHz to 30 GHz), portions of which are approved for use by wireless LAN systems, short range frequency communication enabled devices (i.e. Bluetooth), amateur radio, and personal radio controlled devices, among others. It is understood that other allowable radio frequency bands may be available for use by the camera system 10. The camera system 10 may also use alternative means of wireless communication, such as light waves (e.g. free-space optical), sonic waves, or electromagnetic waves (e.g. electromagnetic induction wireless communication), to send and receive output data and control signals between the camera apparatus 12 and the control apparatus 14.

The camera apparatus wireless communication device 22, in particular the camera apparatus wireless receiver 54, may be bonded to the control apparatus wireless communication device (not shown) and/or controller 70 of the control apparatus 14 such that only control signals transmitted by the controller 70 are recognized and processed by the camera apparatus wireless receiver 54, and vice versa. For example, the controller 70 and camera apparatus wireless receiver 54 can incorporate or utilize an authentication protocol that allows the camera apparatus wireless receiver 54 to recognize and receive signals from the control apparatus 14 only and prevents the receiver 54 from receiving wireless signals originating elsewhere. Bonding the camera apparatus wireless receiver 54 to the controller 70 prevents radio frequency transmissions originating from another source from interfering with or disrupting transmission of control signals from the controller 70 to the camera apparatus wireless receiver 54. For example, the bonding feature allows two or more users to each operate camera systems 10 in close proximity without disrupting one another's wireless communication between the control apparatus 14 and the camera apparatus 12, even if two or more of the camera systems 10 employ similar radio frequencies.

In one embodiment, the control apparatus wireless communication device may have a bandwidth of about 500 MHz. The controller 70 and/or the control apparatus wireless communication device may have multiple output channels corresponding to multiple input channels of the camera apparatus wireless communication device 22 (FIGS. 2-3). In one embodiment, each of the multiple output channels of the controller 70 and/or the control apparatus wireless communication device is allocated to one of the input devices 74 of the controller 70 to transmit the control signal generated by the input device 74. In one embodiment, the controller 70 has at least five output channels, or at least six output channels in another embodiment, or at least 8 output channels in yet another embodiment.

Wireless communication of control signals from the control apparatus 14 to the camera apparatus wireless receiver 54 (or camera apparatus wireless communication device) provides a fast response of the positioner 18 and camera 20 to an input provided by a user. A response time of the camera system 10 can be considered, in one case, to be the time that elapses between the moment the user manipulates an input device 74 of the controller 70 and the moment the positioner 18 and/or the camera 20 moves in response to the resulting control signal. In one embodiment, the response time of the camera system 10 is less than about 0.25 seconds, or less than about 0.1 seconds in another embodiment, or less than about 0.08 seconds in yet another embodiment. In one embodiment, the controller 70 divides the radio frequency band into between 6 and 160 discrete frequencies and includes an automatic frequency hopping algorithm, which regularly switches the frequency of the control signals transmitted to the first wireless receiver 54 between multiple frequencies to prevent jamming or loss of the signal.

Referring back to FIG. 1-3, operation of the camera system 10 will now be described. Before using the camera system 10, the camera apparatus 12 is setup and positioned in a location convenient for capturing the images. The camera apparatus 12 is setup by attaching the support member 24 to the base 16. In one embodiment, the base 16 must be assembled by securing the detachable power pack 30 to the hand truck 33 and then securing the support member 24 to the hand truck 33. For positioning the camera apparatus 12 on uneven ground or deploying the camera apparatus 12 in windy conditions, the stabilizing mechanism 36 may be deployed to provide additional support to the base 16 to substantially reduce the risk of tipping. The camera 20 and/or positioner 18 may be physically attached to an upper portion 28 of the support member 24 for an improved vantage point. In some embodiments, the housing 26 may be secured to the upper portion 28 of the support member 24 for an improved vantage point, and the camera 20 may be attached to the housing 26 or the positioner 18 coupled to the housing 26.

Once the camera 20 is physically secured to the remainder of the camera apparatus 12, the camera 20 may be operatively coupled to the camera apparatus wireless communication device 22. Once the camera 20 is operatively coupled to the camera apparatus wireless communication device 22 (via the interface 45), the camera 20 may be turned on, and the support member/height adjusting mechanism 24 may be operated or adjusted to raise the camera 20 to a height H above the ground. Once the camera apparatus 12 is deployed, the control apparatus 14, including the controller 70 and the display 72, may be powered on.

Operation of the camera system 10 includes receiving input from a user via one or more of the input devices 74. The user input is communicated to the controller 70. The controller 70 communicates the control signals to the control apparatus wireless communication device, which then transmits the control signals to the camera apparatus wireless communication device 22. In one embodiment, the control signals are transmitted directly to the camera apparatus wireless communication device 22. In another embodiment, the control apparatus wireless communication device transmits the control signals to the camera apparatus wireless communication device 22 via a network, such as the Internet or a wireless LAN, for example. The camera apparatus wireless communication device 22 wirelessly receives the control signals and transmits the control signals to the camera 20, the positioner 18, and/or another component of the camera apparatus 12. In response to the control signal, the camera 20 adjusts the zoom and/or record functions accordingly, and/or the positioner 18 adjusts the pan or tilt of the camera accordingly.

The camera 20 captures video images of the event and transmits the video output, via the camera interface 45, to the camera apparatus wireless communication device 22, which transmits the output from the camera 20 to the control apparatus wireless communication device. The control apparatus wireless communication device transmits the output from the camera 20 to the display 72, which assembles and displays the video image.

The system can be computer- or controller-implemented. For example, a computer or controller can be used to generate the control signals from user input, monitor the incoming video output, store the output in a memory, optimize wireless communication between the computer and the camera apparatus 12, or other functions. As used herein “computer” means computers, laptop computers, controllers, processors, computer components and elements of a computer, such as hardware, firmware, virtualized hardware and firmware, combinations thereof, tablet computers, mobile devices, smart phones, or software in execution.

The camera system 10 disclosed herein enables a user to control the camera apparatus 12 from a location remote from the camera apparatus 12. This is particularly helpful to enable the user to seek shelter in inclement weather or rest in a more comfortable location and still control the camera apparatus 12. The camera system 10 also enables a user to quickly and easily move the camera system 10 to a different location, such as moving the camera system 10 from a first field at the conclusion of the event on the first field to a second field prior to the beginning of a second event at the second field. The camera system 10 also enables the user to quickly and easily reposition the camera apparatus 12 to provide different angles or perspectives. The power pack disposed in the base provide the user with a power supply for recharging spare batteries during operation of the camera system. The camera system also provides fast control of the positioner (pan and tilt), which is necessary to enable the user to track and capture the rapid movements of sporting events and the like. The display has a memory and/or a DVR function to provide a redundant recording feature to substantially prevent loss of data if a user should forget to send a control signal to the camera to record. The camera system is also compatible with commercially available consumer electronic camcorders and video cameras, which substantially reduces the cost of the camera system, among other benefits.

Although the subject matter disclosed herein is shown and described with respect to certain embodiments, it is obvious that modifications will occur to those skilled in the art upon reading and understanding the specification, and the present invention includes all such modifications.

What is claimed is:

1. A camera system comprising:
a camera apparatus including:
a base;
a camera movably coupled to the base such that a distance between the camera and the base is adjustable, said camera being configured to provide an output;
a positioner operatively coupled to said camera, wherein the positioner is configured to adjust at least one of a tilt position or a pan position of the camera;
a first wireless receiver operatively coupled to at least one of the camera or the positioner, wherein the first wireless receiver is configured to receive wireless control signals to control at least one of said camera or said positioner; and
a camera apparatus wireless transmitter operatively coupled to said camera to receive and transmit said output; and
a control apparatus including:
a manually controllable controller configured to directly transmit wireless control signals to the first wireless receiver to control at least one of said camera or said positioner;
a second wireless receiver configured to directly receive said output from said wireless transmitter; and
a display operatively coupled to said second wireless receiver and configured to display said output.

2. The camera system of claim 1 wherein the camera system is configured such that the output of the camera is viewable on the display at a position remote from the camera and the control apparatus is operable at a position remote from the camera to thereby control at least one of the camera or the positioner.

3. The camera system of claim 1 wherein the control apparatus is physically decoupled from the camera apparatus.

4. The camera system of claim 1 wherein the camera apparatus is manually movable.

5. The camera system of claim 1 wherein the control apparatus is manually carryable.

6. The camera system of claim 1 wherein the camera is removably coupled to a remainder of the camera system such that the camera can be removed and used as a stand-alone device.

7. The camera system of claim 1 wherein the base is resting on a ground surface, and the camera is adjustable relative to the base in a vertical direction relative to a gravitational frame of reference.

8. The camera system of claim 1 wherein the camera apparatus further includes a height adjusting mechanism coupled to the base and the camera, wherein a height of the height adjusting mechanism is adjustable to vary a distance between the base and the camera.

9. The camera system of claim 8 wherein the height adjusting mechanism is a telescoping pole.

10. The camera system of claim 1 wherein the camera apparatus further includes a power supply electrically attachable to the wireless transmitter, the first wireless receiver, the positioner, and the camera.

11. The camera system of claim 1 wherein the camera apparatus further includes a power supply directly coupled to or positioned in the base to provide ballast thereto.

12. The camera system of claim 1 wherein the camera apparatus further includes a housing directly coupled to said camera or said positioner.

13. The camera system of claim 12 wherein one or more of the first wireless receiver, the wireless transmitter, or a portion of the positioner is positioned within the housing.

14. The camera system of claim 1 wherein the first wireless receiver is operatively coupled to both the camera and the positioner and configured to receive wireless control signals to control both the camera and the positioner.

15. The camera system of claim 1 wherein the positioner comprises at least one servo motor.

16. The camera system of claim 1 wherein the camera system is configured such that the positioner provides a response time of less than about 0.1 seconds from a time a user provides a manual input to the controller to a time the positioner first adjusts at least one of a tilt or a pan of the camera.

17. The camera system of claim 1 wherein the output of the camera is image data relating to images captured by the camera.

18. The camera system of claim 1 further comprising a camera interface electronically and removably attachable to the camera to create an electronic connection between the first wireless receiver and the camera and between the wireless transmitter and the camera.

19. The camera system of claim 1 wherein wireless control signals of the manually controllable controller are radio frequency signals.

20. The camera system of claim 1 wherein the wireless transmitter is configured to transmit said output via radio frequency signals.

21. The camera system of claim 1 wherein the control apparatus includes a memory module configured to automatically store said output received from said wireless transmitter.

22. A camera system comprising:
a camera apparatus including:
a base;
a collapsible extension coupled to said base and extendible away therefrom;
a camera removably coupled to the extension and being configured to provide an output;
a positioner operatively coupled to said camera, wherein the positioner is configured to adjust at least one of a tilt position or a pan position of the camera; and
a first wireless communication device operatively coupled to at least one of the camera or the positioner, wherein the first wireless communication device is configured to wirelessly receive control signals to control at least one of said camera or said positioner and wirelessly transmit said output of the camera;
wherein the camera apparatus is configured to be manually movable; and
a control apparatus including:
a manually controllable controller configured to generate control signals to control at least one of said camera or said positioner;
a second wireless communication device configured to directly wirelessly transmit said control signals to and directly wirelessly receive said output from the first wireless communication device; and
a display operatively coupled to said second wireless communication device and configured to display said output.

23. The camera system of claim 1 wherein the display automatically stores said output.

24. A camera system comprising:
a support apparatus having a base, a support member coupled to the base, and a housing coupled to an upper portion of the support member;
a camera;
a positioner coupled to the housing, wherein the positioner is removably attachable to the camera and configured to rotate the camera in one or more directions;
a first wireless communication device coupled to the housing, the first wireless communication device being configured to wirelessly receive control signals and forward the control signals to at least one of the camera or the positioner and to receive video data from the camera and wirelessly transmit the video data; and
a manually controllable controller physically decoupled from the support apparatus and having a second wireless communication device configured to send the control signals to and receive video data from the first wireless communication device, the controller having a display configured to display the received video data.

25. The camera system of claim 24 wherein the first wireless communication device includes a radio frequency receiver and a radio frequency transmitter separate from the radio frequency receiver.

26. The camera system of claim 24 wherein the second wireless communication device is configured to directly communicate with the first wireless communication device.
